(19) United States
(12) Patent Application Publication
(10) Pub. No.: US 2010/0159246 A1
(43) Pub. Date: Jun. 24, 2010

(54) PROCESS FOR PRODUCING OXIDE CRYSTAL FINE PARTICLES

(75) Inventors: Tomohiro Sakai, Tokyo (JP); Yoshihisa Beppu, Tokyo (JP); Hiroyuki Suzuki, Haibara-gun (JP); Nobuo Inuzuka, Haibara-gun (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Tokyo (JP)

(21) Appl. No.: 12/717,228

(22) Filed: Mar. 4, 2010

Related U.S. Application Data
(63) Continuation of application No. PCT/JP08/65342, filed on Aug. 27, 2008.

(30) Foreign Application Priority Data
Sep. 7, 2007 (JP) 2007-233137

(51) Int. Cl. C01F 17/00; B32B 5/16

(52) U.S. Cl. 428/402; 423/263; 977/775

(57) ABSTRACT

To provide a process for producing fine particles of crystalline oxide which have high crystallinity, are excellent in uniformity of the composition and particle diameter, and have a small particle diameter, and such fine particles of crystalline oxide.

A process for producing fine particles of crystalline oxide, which comprises:

a step of obtaining a melt containing an oxide of M (M is at least one member selected from the group consisting of Ce, Ti, Zr, Al, Fe, Zn, Mn, Cu, Co, Ni, Bi, Pb, In, Sn and rare earth elements (excluding Ce)) and B₂O₃,

a step of rapidly cooling the melt to form an amorphous material,

a step of pulverizing the amorphous material to obtain a pulverized material having a volume-based particle size distribution within a range of from 0.1 to 40 μm,

a step of heating the pulverized material to precipitate an oxide crystal containing M in the pulverized particles, and

a step of separating components other than the oxide crystal containing M from the crystal-precipitated particles to obtain fine particles of crystalline oxide containing M, in this order.

### TECHNICAL FIELD

The present invention relates to a process for producing fine particles of crystalline oxide, particularly to a process to easily obtain fine particles of crystalline oxide which have high crystallinity, are excellent in uniformity of the composition and particle diameter and have a small particle diameter, and such fine particles.

### BACKGROUND ART

In recent years, particularly along with high integration/high functionality of semiconductor integrated circuits, it has been desired to develop microfabrication techniques for microsizing/high densification. In a process for producing semiconductor devices, particularly in a process for forming multilayer wirings, a technique for planarization of interlayer dielectric films or embedded wirings is important. That is, as wirings have become multi-layered to meet microsizing/high densification in the semiconductor production process, the surface irregularities at each layer tend to be large, and in order to prevent such a problem that a difference in level exceeds the focal depth of lithography, a technique for high planarization in the process for forming multilayer wirings has become important.

As a material for wirings, attention has been drawn to Cu, since it has a low specific resistance as compared with an Al alloy that used to be commonly employed, and it is excellent in electromigration resistance. With Cu, the vapor pressure of its chloride gas is low, and it can hardly be processed into wirings by reactive ion etching (RIE) which has been commonly used. Therefore, a damascene method is employed for the formation of its wirings. This is a method wherein recessed portions such as groove patterns or via holes for wiring are formed in an insulating layer, then a barrier layer is formed, and then Cu is deposited by sputtering or plating to fill the grooves, and then, excess Cu and barrier layer are removed by chemical mechanical polishing (hereinafter referred to as CMP) until the insulating layer surface other than the recessed portions will be exposed, thereby to planalize the surface and form embedded metal wirings. Multilayering is carried out in such a manner that a SiO₂ film as an interlayer dielectric film is deposited on the embedded wirings, the SiO₂ film is planalized by CMP, and then the next embedded wirings will be formed. In recent years, a dual damascene method is mainly used wherein such Cu wirings having Cu embedded in recessed portions, and via holes are simultaneously formed (e.g. Patent Document 1).

In the formation of such Cu-embedded wirings, in order to prevent diffusion of Cu into the insulating layer, as a barrier layer, tantalum, a tantalum alloy or tantalum nitride is, for example, formed. Accordingly, it is necessary to remove the exposed barrier layer by CMP, at portions other than the Cu-embedded wiring portions. Further, in order to electrically separate elements such as transistors, shallow trench isolation (hereinafter referred to as STI) is employed. This is a method wherein while the element regions are masked with a SiN film, trenches are formed in a silicon substrate, then a SiO₂ film is deposited as an insulating layer to fill the trenches, and excess SiO₂ film on the SiN film is removed by CMP thereby to electrically separate the element regions. In the formation of such Cu-embedded wirings, the wafer surface to be planalized is, of course, a surface on which a device is to be formed, and therefore, substantially no processing defects should be formed in the polishing step. One of the most serious problems as such processing defects is formation of scratches. Even if scratches are of a size which satisfies the design rules of the device, in recessed portions inside the scratches, W, Cu, etc. are known to remain in e.g. a CMP process of metal thereby to cause deterioration of the yield (e.g. Non-Patent Document 1), and it is therefore necessary to minimize scratches remaining after the polishing.

Heretofore, as an abrasive for such semiconductor CMP, a slurry (hereinafter sometimes referred to as a polishing slurry) has been used which is prepared by dispersing oxide fine particles of cerium oxide or aluminum oxide as abrasive grains in water or in an aqueous medium, and adding additives (a pH-adjusting agent, a dispersant, etc.) thereto.

It is considered that scratches are basically formed by excessively large coarse particles, and accordingly, in order to overcome such a problem, a method of reducing inclusion of particles having large diameters in the polishing slurry, has been studied. For example, Patent Document 2 proposes that formation of scratches can be suppressed while providing a high polishing ability by using cerium oxide particles which have a polycrystal structure formed from at least two crystallites and which can provide active surfaces contributing to the polishing, while such a polycrystal structure is disintegrated during the polishing. However, there has still remained a problem such that when such particles are employed as abrasive grains, fine scratches are still formed which are considered to be attributable to the presence of coarse particles. In recent years, along with high integration and high functionality of semiconductor devices, it has been required, for example, to reduce formation of scratches having sizes exceeding 0.2 μm on a 8-inch wafer to a level of at most 1,500, more preferably at most 1,000, and it is urgently required to develop a polishing slurry capable of highly preventing formation of fine scratches.

In order to solve the above problem, the present inventors have proposed in Patent Document 3 a method to obtain fine particles of CeO₂ crystal by a glass crystallization method which comprises crystallizing oxide fine particles in a glass matrix having a specific composition, followed by removing the glass matrix component, and a polishing slurry containing such fine particles. By this method, it is possible to obtain Fine particles of CeO₂ crystal having small particle diameters and being excellent in uniformity of the particle diameter, and when the polishing slurry containing such fine particles is used for semiconductor CMP, there is a merit such that formation of fine scratches can be prevented. However, even when the method of Patent Document 3 is employed, depending upon the crystallization temperature or the glass composition, slight fluctuation in the particle diameter is likely to result, and due to an influence of such a fluctuation, the stress exerted to the respective abrasive grains is likely to be changed, and abrasive grains on which the stress is concentrated may cause formation of scratches in the polishing.

Patent Document 1: JP-A-2004-55861 (Claims)

Patent Document 2: Japanese Patent No. 3,727,241 (Claims)

Patent Document 3: WO2006/049197

Non-Patent Document 1: Detailed description; Semiconductor CMP technology, Toshiro Doi, published by Kogyo Chousa Kai, p. 321 (2000)

### DISCLOSURE OF THE INVENTION

### Object to be Accomplished by the Invention

The present invention relates to a process for producing fine particles of crystalline oxide (hereinafter referred to also as “fine particles”) and particularly has an object to provide a process to easily obtain fine particles which have high crystallinity, are excellent in uniformity of the composition and particle diameter and have a small particle diameter, and to provide such fine particles.

### Means to Accomplish the Object

In order to accomplish the above object, the present invention have conducted an extensive study on a process to obtain polishing particles which have a small particle diameter, and which are excellent in uniformity of the particle diameter, and as a result, have found it possible to obtain fine particles of crystalline oxide excellent in uniformity of the particle diameter by rapidly cooling a melt and finely pulverizing an amorphous material thereby formed, in the glass crystallization method disclosed in Patent Document 3. The present invention has been accomplished on the basis of such a discovery and provides the following.

A process for producing fine particles of crystalline oxide, which comprises a step of obtaining a melt containing an oxide of M (M is at least one member selected from the group consisting of Ce,Ti, Zr, Al, Fe, Zn, Mn, Cu, Co, Ni, Bi, Pb, In, Sn and rare earth elements (excluding Ce)) and B₂O₃, a step of rapidly cooling the melt to form an amorphous material, a step of pulverizing the amorphous material to obtain a pulverized material having a volume-based particle size distribution within a range of from 0.1 to 40 μm, a step of heating the pulverized material to precipitate a crystalline oxide containing M in the pulverized particles, and a step of separating components other than the crystalline oxide containing M from the crystal-precipitated particles to obtain fine particles of crystalline oxide containing M, in this order.

Fine particles of crystalline oxide, wherein the ratio of the crystallite diameter calculated by using Scherrer's method from the X-ray diffraction measurement to the average primary particle diameter calculated by spherical approximation from the specific surface area measurement by BET method is within a range of crystallite diameter:average primary particle diameter=1:0.8 to 1:2.5; the average primary particle diameter is from 5 to 100 nm; and the variation coefficient of the particle diameter is from 0.05 to 0.3, where the variation coefficient of the particle diameter is a value obtained by dividing the standard deviation of the particle size distribution obtained by measurement from the transmission electron microscopic photograph, by the number average particle diameter.

### EFFECTS OF THE INVENTION

By the process of the present invention, it is possible to selectively obtain fine particles which have a small particle diameter and which are excellent in uniformity of the particle diameter. Accordingly, it is possible to prevent formation of scratches on the polished surface by using a polishing slurry containing such fine particles in precision polishing such as semiconductor CMP.

### BRIEF DESCRIPTION OF DRAWING

FIG. 1 is a transmission electron microscopic photograph of CeO₂ fine particles obtained in an Example (Example 1) of the present invention.

### BEST MODE FOR CARRYING OUT THE INVENTION

Now, the present invention will be described in detail.

The process of the present invention comprises a step of obtaining a melt composed of the prescribed starting material (hereinafter referred to as “melting step”), a step of rapidly cooling the melt to form an amorphous material (hereinafter referred to as “rapid cooling step”), a step of pulverizing the amorphous material to obtain a pulverized material (hereinafter referred to as “pulverization step”), a step of heating the pulverized material to precipitate a crystalline oxide containing M in the pulverized particles (hereinafter referred to as “crystallization step”), and a step of separating components other than the crystalline oxide containing M from the crystal-precipitated particles to obtain fine particles of crystalline oxide containing M (hereinafter referred to as “separation step”), in this order.

Melting Step

In the melting step, a melt containing an oxide of M (M is at least one member selected from the group consisting of Ce, Ti, Zr, Al, Fe, Zn, Mn, Cu, Co, Ni, Bi, Pb, In, Sn and rare earth elements excluding Ce) and B₂O₃, is obtained. Further, “mol % based on oxide” is a mol percentage based on a molecule wherein the metal oxide takes the maximum oxidation number and is one calculated from the charged amount of the starting materials, unless otherwise specified. Hereinafter, rare earth elements excluding Ce are represented by E.

In the melting step, it is preferred to obtain a melt containing, as represented by mol % based on oxide, from 5 to 70% of the oxide of M and from 30 to 95% of B₂O₃. The melt having such a composition has a suitable viscosity and in the subsequent rapid cooling step, can be vitrified to obtain an amorphous material without crystallization of the melt.

Further, the melt preferably contains an oxide of R (R is at least one member selected from the group consisting of Mg, Ca, Sr and Ba). By the incorporation of the oxide of R, it becomes easy to adjust the melting temperature and the viscosity of the melt. In such a case, the proportions of the respective components contained in the melt are preferably within ranges of, as represented by mol % based on oxide, from 5 to 50% of the oxide of M, from 10 to 50% of the oxide of R and from 30 to 75% of B₂O₃. The melt having such a composition has a suitable viscosity and in the subsequent rapid cooling step, can be vitrified to obtain an amorphous material without crystallization of the melt.

Specifically, it is preferred that the proportion of the oxide of M in the melt is at most 50 mol %, the proportion of the oxide of R is at least 10 mol %, or the proportion of B₂O₃ is at least 30 mol %, whereby in the rapid cooling step, the melt can be vitrified to obtain an amorphous material without crystallization. On the other hand, it is preferred that the proportion of the oxide of M in the melt is at least 5%, the oxide of R is at most 50 mol %, or B₂O₃ is at most 75 mol %, whereby in the subsequent crystallization step, the crystalline oxide containing M can be sufficiently precipitated. More preferred is a melt containing from 20 to 40 mol % of the oxide of M, from 10 to 40 mol % of the oxide of R and from 40 to 60 mol % of B₂O₃, whereby fine particles having the desired characteristics can be more easily obtainable, and the yield can be made high.

Further, it is preferred that the proportion of the oxide of R contained in the melt is within a range of from 20 to 50 mol % to B₂O₃, whereby in the rapid cooling step, the melt can be vitrified without crystallization.

The melt is obtained by heating a mixture prepared by mixing a compound as a M source, a compound as a B source and, if necessary, a compound as a R source in the prescribed proportions, in the presence of oxygen.

Here, the composition of this mixture is basically one which theoretically corresponds to the composition of the melt after the melting. However, during the melting treatment, a component which is likely to be lost by e.g. evaporation, such as B, may be present, and accordingly, the composition of the melt after the melting may sometimes be slightly different from the mol % based on oxide calculated from the charged amounts.

As the M source, the following may preferably be used depending upon the type of M (in each of the following formulae, n represents a hydration number and includes a case of an anhydride where n=0, and the formulae include the respective oxysalt.). The M source not only becomes the final product but also serves as a part of the glass-forming component in cooperation with the after-mentioned R and B sources by melting.

When M=Ce: It is preferred to use cerium oxide (CeO₂, Ce₂O₃) and cerium carbonate (Ce₂(CO₃)₃.nH₂O). On the other hand, cerium chloride (CeCl₃.nH₂O), cerium nitrate (Ce(NO₃)₃.nH₂O), cerium sulfate (Ce₂(SO₄)₃.nH₂O), cerium diammonium nitrate (Ce(NH₄)₂(NO₃)₆) and cerium fluoride (CeF₃) may also be used.

When M=Ti: rutile or anatase (each being TiO₂), titanium chloride (TiCl₄), titanium sulfate (Ti(SO₄)₂), titanium fluoride (TiF₄), barium titanate (BaTiO₃), strontium titanate (SrTiO₃)

When M=Zr: zirconium oxide (ZrO₂), zirconium hydroxide (Zr(OH)₄), zirconium chloride (ZrCl₄.nH₂O), zirconyl nitrate (ZrO(NO₃)₂.nH₂O), zirconium sulfate (Zr(SO₄)₂.nH₂O), zirconium fluoride (ZrF₄) and ceria, magnesia, calcia-stabilized zirconia ((Ce,Ca,Mg)ₓZr₁₋ₓO₂) [0<x≦0.2]

When M=Al: aluminum oxide (Al₂O₃), aluminum hydrooxide (Al(OH)₃), aluminum chloride (AlCl₃.nH₂O), aluminum sulfate (Al₂(SO₄)₃.nH₂O), aluminum fluoride (AlF₃), aluminum borate (Al₁₀B₄O₂₁.nH₂O), boehmite (AlO(OH))

When M=Fe: iron oxide (FeO, Fe₂O₃, Fe₃O₄), iron oxide hydroxide (FeO(OH)), iron nitrate (Fe(NO₃)₃.nH₂O), iron chloride (FeCl₂.nH₂O, FeCl₃.nH₂O), iron sulfate (FeSO₄.nH₂O), iron fluoride (FeF₂, FeF₃)

When M=Zn: zinc oxide (ZnO), zinc carbonate (ZnCO₃), zinc chloride (ZnCl₂), zinc sulfate (ZnSO₄.nH₂O), zinc fluoride (ZnF₂.nH₂O), zinc borate (Zn₂B₆O₁₁.nH₂O)

When M=Mn: manganese oxide (MnO, Mn₃O₄, Mn₂O₃, MnO₂), manganese carbonate (MnCO₃.nH₂O), manganese nitrate (Mn(NO₃)₂.nH₂O), manganese chloride (MnCl₂.nH₂O), manganese sulfate (MnSO₄. nH₂O)

When M=Cu: copper oxide (CuO, Cu₂O), copper carbonate (CuCO₃.nH₂O), copper hydroxide (Cu(OH)₂), copper chloride (CuCl, CuCl₂.nH₂O), copper sulfate (CuSO₄.nH₂O)

When M=Co: It is preferred to use at least one member selected from the group consisting of cobalt oxide (CoO or Co₃O₄), cobalt carbonate (CoCO₃) and cobalt nitrate (Co(NO₃)₂.6H₂O).

When M=Ni: nickel oxide (NiO), nickel nitrate (Ni(NO₃)₂.nH₂O), nickel hydroxide (Ni(OH)₂), nickel chloride (NiCl₂.nH₂O), nickel sulfate (NiSO₄.nH₂O), nickel fluoride (NiF₂)

When M=Bi: bismuth oxide (Bi₂O₃) or bismuth carbonate ((BiO)₂CO₃)

When M=Pb: lead oxide (PbO) or lead carbonate (PbCO₃)

When M=In: It is preferred to use indium oxide (In₂O₃), but indium fluoride (InF₃) may also be used.

When M=Sn: tin oxide (SnO₂ or SnO), tin chloride (SnCl₂.nH₂O, SnCl₄.nH₂O), tin sulfate (SnSO₄), tin fluoride (SnF₂, SnF₄). It is particularly preferred to use SnO₂, since evaporation at the time of melting is little.

When M=E: It is preferred to use an oxide of Sc, Y and each element such as La, Pr, Nd, Pm, Sm, Eu, Gd, Tb, Dy, Ho, Er, Tm, Yb or Lu belonging to lanthanoid (atomic No. 57 to 71) belonging to Group 3A of the periodic table (E₂O₃). On the other hand, at least one member selected from the group consisting of each carbonate (such as E₂(CO₃)₂.nH₂O), each chloride (ECl₃.nH₂O), each nitrate (E(NO₃)₃.nH₂O), each sulfate (E(SO₄)₂.nH₂O) and each fluoride (EF₃) may be used.

In the process of the present invention, when M=Ce, fine particles of CeO₂ crystal are obtainable as the final product, and such particles are applicable as abrasive grains excellent in the polishing rate for a silicon dioxide material, particularly SiO₂, to be used as a constituting material for e.g. an interlayer dielectric film, such being desirable. Further, at that time, if R=Ca, it becomes easy to obtain fine particles of CeO₂ crystal having a small particle diameter, such being particularly preferred.

Next, as the B source, it is preferred to use at least one member selected from the group consisting of boron oxide (B₂O₃) and boric acid (H₃BO₃). Further, a borate of M or R may also be used.

Further, as the R source, it is preferred to use at least one member selected from the group consisting of an oxide of R (R oxide) or its carbonate (RCO₃).

Further, at least one member selected from the group consisting of a nitrate of R (R(NO₃)₂.pH₂O), a chloride of R (RCl₂.pH₂O), a sulfate of R (RSO₄.pH₂O) and a fluoride of R (RF₂) may also be used (in each of the above formulae, p represents a hydration number and includes a case of an anhydride where p=0).

Further, when R=Ba, Sr, there may be a case where in the subsequent crystallization step, a composite crystalline oxide of R and M will precipitate. Specifically, when M=Bi and R=Sr, or when M=Ti and R=Ba, such a composite crystalline oxide is likely to be formed.

With respect to the above-described M, B and R sources, the purities of the constituting materials in the mixture are not particularly limited within a range not to deteriorate the desired properties, but the purities excluding hydration water are preferably at least 99%, more preferably at least 99.9%.

Further, the particle sizes of the constituting materials are also not particularly limited so long as they are within a range where a uniform melt is obtainable by melting. Further, it is preferred that the above constituting materials are mixed in a dry or wet system by means of a mixing/pulverization means such as a ball mill or a planetary mill and then melted.

The melting may be carried out in atmospheric air, but is preferably carried out while controlling the oxygen partial pressure or the oxygen flow rate. The crucible to be used for the melting may be made of alumina, platinum or platinum containing rhodium, and a refractory may also be used.

Further, the melting is preferably carried out by using a resistance heating furnace, a high frequency induction furnace or a plasma arc furnace. The resistance heating furnace is preferably an electric furnace provided with a heating element made of a metal such as a dichromic alloy, silicon carbide, molybdenum silicate or lanthanum chromite. The high frequency induction furnace may be one which is provided with an induction coil and capable of controlling the output. The plasma arc furnace may be one having electrodes made of e.g. carbon, whereby a plasma arc generated can be utilized. Further, the melting may be carried out by direct heating by means of infrared radiation or laser.

The above mixture may be melted in a powder state or may be preliminarily molded and then melted. In a case where a plasma arc furnace is to be employed, a preliminarily molded mixture may be melted as it is and rapidly cooled.

The melting of the above mixture is preferably carried out at a temperature of at least 1,300° C., more preferably from 1,400 to 1,600° C. Further, the obtained melt may be stirred in order to increase the uniformity.

Rapid Cooling Step

In the rapid cooling step, the melt obtained as described above is rapidly cooled to about room temperature to form an amorphous material. The rapid cooling rate is preferably at least 100° C./sec., more preferably at least 1×10⁴° C./sec. from the industrial viewpoint, the rapid cooling rate is preferably at most 1×10¹⁰° C./sec.

In the rapid cooling step, suitably employed is a method of dropping the melt between twin rollers rotating at a high speed thereby to obtain a flake-form amorphous material, or a method of continuously winding up a fiber-form amorphous material (long fiber) from the melt on a drum rotating at a high speed. As such twin rollers and drum, it is preferred to use ones made of a metal or ceramics. Otherwise, a fiber-form amorphous material (short fiber) may be obtained by using a spinner provided with pores on its side wall and rotating at a high speed. By using such devices, the melt can effectively be rapidly cooled to form an amorphous material having a high purity.

In a case where the amorphous material is in a flake-form, it is preferred to carry out the rapid cooling so that its average thickness would be at most 200 μm, more preferably at most 100 μm. Further, in the case of a fiber-form, it is preferred to carry out the rapid cooling so that its average diameter would be at most 50 μm, more preferably at most 30 μm. By adjusting the average thickness or the average diameter to have the above upper limit value, it is possible to increase the crystallization efficiency in the subsequent crystallization step.

Here, in the case of a flake-form, the average thickness can be measured by a vernier caliper or a micrometer. Further, in the case of a fiber-form, the average diameter can be measured by the above-mentioned method or by an observation by means of a microscope.

Pulverization Step

In the pulverization step, the amorphous material obtained in the above rapid cooling step is pulverized until its volume-based particle size distribution will be from 0.1 to 40 μm, to obtain a pulverized material. By adjusting the volume-based particle size distribution of the pulverized material to be at least 0.1 μm, the desired fine particles of crystalline oxide will be readily obtainable, such being preferred. On the other hand, by adjusting the volume-based particle size distribution of the pulverized material to be at most 40 μm, the particle diameter of the desired fine particles can be made small and highly uniform. The reason is not clearly understood, but may be considered to be such that as the coarse particles are removed by the pulverization, the specific surface area of the amorphous material will increase, and the oxide of M remaining in the amorphous material without not being completely oxidized, is likely to be oxidized in the subsequent crystallization step, whereby the crystal precipitation is unified. For example, in the case of M=Ce, if Ce₂O₃(Ce³⁺) remains in the amorphous material, it will take in oxygen by crystallization to form CeO₂(Ce⁴⁺), and this oxygen-taking in process is considered to take place uniformly by the pulverization step.

Further, in the present invention, the above volume-based particle size distribution of the pulverized material being from 0.1 to 40 μm means that the volume-based particle size of the pulverized material is substantially from 0.1 to 40 μm, and a pulverized material of at most 0.1 μm may be contained in an amount of at most 10 mass %.

Such a volume-based particle size distribution of the pulverized material is more preferably within a range of from 0.1 to 30 μm, further preferably within a range of from 0.1 to 20 μm.

Further, D₉₀ of the pulverized material is preferably at most 20 μm, more preferably at most 10 μm. Here, D₉₀ represents a particle diameter when in a volume-based cumulative particle size distribution curve of the pulverized material, the integrated amount as accumulated from the small particle size side, becomes to be 90%.

It is particularly preferred that the volume-based particle size distribution of the pulverized material of the present invention is within a range of from 0.1 to 20 μm, and D₉₀ is at most 10 μm.

Further, at the time of the pulverization, it is preferred to carry out the pulverization in a dry system by using a ball mill or a jet mill. However, the pulverization may be carried out in a wet system by using various types of a wet mill, crusher or mortar.

Crystallization Step

In the crystallization step, the above pulverized material is heated to precipitate a crystalline oxide containing M in the pulverized particles. The heating temperature in the crystallization step is preferably from 600 to 900° C. If the heating temperature is lower than 600° C., crystals tend to hardly precipitate even if heating is continuously carried out for about 24 hours. On the other hand, if it exceeds 900° C., the crystal-precipitated particles may be fused, such being undesirable. The heating temperature is more preferably from 650 to 850° C.

Here, the crystal precipitation comprises two stages of nuclei-formation and the subsequent crystal growth, and these two stages may be carried out at different temperatures, respectively.

In a temperature range of from 600 to 900° C., as the heating temperature is made higher, the amount and particle diameter of the crystal to be precipitated tend to be larger, and accordingly, the crystallization temperature may be set depending upon the desired particle diameter. Further, the heating temperature is influential over the crystal system of the crystalline oxide to be precipitated, and accordingly, the heating temperature may be set depending upon the desired crystal system.

In the crystallization step, it is preferred to maintain the heating temperature within the above-mentioned range for from 0.5 to 96 hours, whereby the oxide containing M can sufficiently be crystallized. The longer the heating time, the larger the amount of the crystalline oxide to be precipitated, and the larger the particle diameter of the crystal to be precipitated. Accordingly, the heating time may be set depending upon the desired amount and particle diameter of the crystal to be precipitated. Further, the heating time is influential over the crystal system of the crystalline oxide to be precipitated, and accordingly, the heating temperature may be set depending upon the desired crystal system. The heating time is preferably from 1 to 32 hours, more preferably from 1 to 8 hours.

In the crystallization step, by crystallization of the amorphous material, crystal-precipitated particles will be formed wherein a crystalline oxide containing M is precipitated as crystal. Depending upon the composition of the amorphous material, a borate of R, a composite salt of boric acid, etc. may also be precipitated. Such components other than the crystalline oxide containing M can be removed in the subsequent separation step.

Separation Step

In the separation step, components other than the crystalline oxide containing M are separated from the crystal-precipitated particles obtained in the crystallization step to obtain fine particles.

The separation step preferably includes a step of adding an acid to the crystal-precipitated particles. By adding an acid to the crystal-precipitated particles, it is possible to easily elute and remove the components other than the crystalline oxide containing M. As such an acid, an inorganic acid such as hydrochloric acid or nitric acid, or an organic acid such as acetic acid, oxalic acid or citric acid may, for example, be used.

At that time, in order to accelerate the elution, the acid may be warmed, and a shaking operation or ultrasonic irradiation may be used in combination. By such elution treatment, a part of the crystalline oxide containing M may sometimes be dissolved, such being rather preferred in that the particle diameter may thereby be unified. Further, such elution treatment may be repeated several times.

After the elution treatment, washing with pure water may be carried out, as the case requires, to obtain the fine particles. Further, to obtain a powder of the fine particles, drying may also be carried out after the washing.

Characteristics of Fine Particles

The fine particles of the present invention have an average primary particle diameter (which means a long diameter in the case of anisotropic particles) within a range of from 5 to 100 nm. Here, the average primary particle diameter is a particle diameter calculated by spherical approximation from the specific surface area measurement by a nitrogen adsorption method (BET method). By adjusting the average primary particle diameter to be at least 5 nm, the polishing rate can be improved. On the other hand, by adjusting the average primary particle diameter to be at most 100 nm, precise polishing becomes possible, and formation of scratches on the surface polished can be prevented. The average primary particle diameter is preferably within a range of from 5 to 50 nm, further preferably from 10 to 50 nm.

Next, the ratio of the crystallite diameter to the average primary particle diameter (hereinafter referred to also as the particle diameter ratio) of the fine particles of the present invention is within a range of crystallite diameter:average primary particle diameter=1:0.8 to 1:2.5. Here, the crystallite diameter is a crystallite diameter calculated by using Scherrer's method from the X-ray diffraction measurement. When the particle diameter ratio is within the above range, it becomes possible to prevent formation of scratches on the surface to be polished, while maintaining a high polishing performance, at the time of using the fine particles of the present invention as abrasive grains for polishing.

The reason as to why it is possible to suppress formation of scratches by adopting the particle diameter ratio within the above range, is not clearly understood, but the present inventors considers that it may be as follows. Firstly, by adjusting the particle diameter ratio to be larger than 1:0.8, it becomes easy to maintain the single crystal form and to minimize crystal lattice defects, whereby it becomes possible to constantly secure active sites contributing to the improvement of the polishing rate, on the outer surface of abrasive grains for polishing. As a result, even in a case where scratches are formed on the surface in an intermediate stage during the polishing process, such scratches may be diminished as the polishing progresses. On the other hand, by adjusting the particle diameter ratio to be smaller than 1:2.5, the shape of the fine particles can easily be maintained to be a single crystal form, whereby it becomes possible to suppress formation of scratches by inclusion of coarse particles made of polycrystal. Such a particle diameter ratio is more preferably within a range of from 1:1.0 to 1:2.0, further preferably within a range of from 1:1.0 to 1:1.8.

Further, it is particularly preferred that the average primary particle diameter of the fine particles of the present invention is within a range of from 10 to 50 nm, and the particle diameter ratio is within a range of crystallite diameter:average primary particle diameter=1:1.0 to 1:1.8.

Further, the variation coefficient of the particle diameter of the fine particles of the present invention is within a range of from 0.05 to 0.3. Here, the variation coefficient of the particle diameter is a value obtained by dividing the standard deviation of the particle size distribution obtained by measurement from the transmission electron microscopic photograph, by the number average particle diameter, and it represents the degree of fluctuation in the particle diameter. The variation coefficient of the particle diameter is preferably at least 0.05, whereby preparation of the fine particles becomes easy. On the other hand, the variation coefficient of the particle diameter is preferably at most 0.3, whereby the particle diameter can be made highly unified, and formation of scratches can be highly suppressed.

In a case where the above fine particles are to be used as abrasive grains, the fine particles are preferably made of at least one member selected from the group consisting of ceria (CeO₂), titania (TiO₂), tin oxide (SnO₂), zinc oxide (ZnO), alumina (Al₂O₃), manganese oxide (MnO₂), zirconia (ZrO₂) and a mutual solid solution thereof.

Particularly, in a case where the fine particles are made of CeO₂ (in a case where M=Ce), it is preferred to use a polishing slurry containing such fine particles for semiconductor CMP, whereby it is possible to readily obtain a slurry excellent in the polishing rate for a silicon dioxide material, particularly SiO₂, to be used as a constituting material for e.g. an interlayer dielectric film.

A polishing slurry can be prepared by dispersing the above fine particles in a suitable liquid medium. At that time, the liquid medium is not particularly limited, but it is preferred to use water or an aqueous medium composed mainly of water, in order to maintain the viscosity i.e. the fluidity of the slurry. Here, in a case where a desired viscosity cannot be obtained, a viscosity-controlling agent may be added to the slurry. Further, for the purpose of improving the polishing characteristics or the dispersion stability, it is also possible to incorporate a solvent having a high dielectric constant, such as methanol, ethanol, propanol, ethylene glycol or propylene glycol.

The content of the fine particles in the polishing slurry may suitably be set in consideration of the polishing rate, uniform dispersibility, stability during the dispersion, etc. In the present invention, it is preferred that the fine particles are contained in an amount of from 0.1 to 40 mass %, based on the total mass of the polishing slurry. If the content is less than 0.1 mass %, the polishing rate tends to be inadequate. On the other hand, if it exceeds 40 mass %, the viscosity of the slurry tends to be high, and handling as a polishing slurry tends to be difficult. The content is more preferably from 0.5 to 10 mass %.

The above fine particles may be used for a slurry as they are, but they are preferably pulverized in the powder state, more preferably wet-pulverized in the form of a suspension having water or an aqueous medium added, followed by dispersion to obtain a slurry. For example, the above pulverization and dispersion are carried out by means of an apparatus such as a dry jet mill, a ball (beads) mill or a planetary mill to let powder particles collide with one another, a high pressure homogenizer to let plural fluids collide with one another or an ultrasonic irradiation apparatus. Further, in order to remove agglomerated particles or coarse particles, filtration treatment by means of a filter, or centrifugal separation may be carried out. Here, the dispersed particle diameter of the polishing slurry is preferably from 10 to 300 nm, whereby the polishing rate will be excellent. Particularly preferably, the dispersed particle diameter is from 20 to 200 nm.

Further, depending upon the particular application, a dispersant, a pH-adjusting agent, a pH-buffering agent, an oxidizing agent, a resin serving as a stabilizer for the fine particles, a dishing or erosion preventing agent, etc., may be incorporated to the slurry within a range not to impair the excellent polishing characteristics of the polishing slurry of the present invention. The dispersing agent may, for example, be ammonium polycarboxylate or ammonium polyacrylate. As the pH-adjusting agent or the pH-buffering agent, an inorganic acid such as nitric acid, a carboxylic acid such as succinic acid or citric acid, aqueous ammonia, a quaternary ammonium hydroxide such as tetramethylammonium hydroxide, an alkali metal hydroxide, etc., may suitably be used. Here, the pH of the slurry is controlled to be preferably from 2 to 10, particularly preferably from 4 to 9.

### EXAMPLES

Now, the present invention will be described with reference to Examples, but it should be understood that the present invention is by no means thereby restricted.

Evaluations

(1) Evaluation of Pulverized Material

Volume-based particle size distribution: obtained by means of a laser diffraction type wet particle size distribution measuring apparatus (model: LA-920, manufactured by HORIBA, Ltd.).

(2) Evaluation of Fine Particles

Crystallite diameter: calculated by Scherrer's equation from the stretch of the diffraction line measured by an X-ray diffraction apparatus (model: RINT2500, manufactured by Rigaku Corporation).

Average primary particle diameter: calculated by spherical approximation from the specific surface area measurement (model: ASAP2020, manufactured by Shimadzu Corporation) by a nitrogen adsorption method (BET method).

Variation coefficient of the particle diameter: By using a photograph taken by a transmission electron microscope (model: JEM-1230, manufactured by JEOL Ltd.), the variation coefficient was calculated by dividing the standard deviation of the particle size distribution obtained by measuring the particle size distribution of 900 fine particles observed in the photograph, by the number average particle diameter.

(3) Evaluation of Dispersion

Median diameter: obtained by using a particle size distribution measuring apparatus (model: UPA-ST150, manufactured by Nikkiso Co., Ltd.).

### Example 1

Cerium oxide (CeO₂), barium carbonate (BaCO₃) and boron oxide (B₂O₃) were weighed so that they will be 33.4%, 13.3% and 53.3%, respectively, as represented by mol % based on CeO₂, BaO and B₂O₃, and thoroughly wet-mixed in an automatic mortar by means of a small amount of ethanol, followed by drying to obtain a starting material mixture.

The obtained starting material mixture was filled in a platinum container (containing 10 mass % of rhodium) provided with a nozzle for dropwise addition of a melt and heated at 1,500° C. for two hours in an electric furnace using molybdenum silicate as a heating element and completely melted (melting step). Then, the nozzle portion was heated, and the melt was dropped on twin rolls (roll diameter: 150 mm, roll rotational speed: 300 rpm, roll surface temperature: 30° C.) made of SUS316 installed below the electric furnace, to obtain a flake-form solid (rapid cooling step). The obtained flake-form solid was transparent and confirmed to be an amorphous material as a result of the powder-X-ray diffraction.

This amorphous material was pulverized for 8 hours by a dry ball mill using zirconia balls with 5 mm in diameter to obtain a pulverized material (pulverization step). The volume-based particle size distribution of the obtained pulverized material was within a range of from 0.5 μm to 15 μm, and its D₉₀ was 6.3 μm.

The obtained pulverized material was heated at 700° C. for 4 hours to precipitate CeO₂ crystal (crystallization step).

Then, this powder of crystal-precipitated particles was added to a 1 mol/L acetic acid aqueous solution maintained at 80° C. and stirred for 12 hours, followed by centrifugal separation, washing with water and drying to obtain fine particles (separation step).

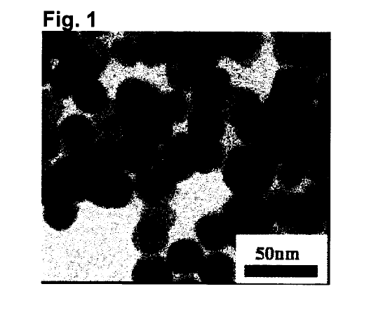

The mineral phase of the obtained fine particles was identified by using an X-ray diffraction apparatus, whereby they were found to be fine particles having high crystallinity made of a CeO₂ single phase (density: 7.2 g/cm³), which exhibited a cubic crystal structure, and showed a diffraction peak agreeing with known CeO₂ (JCPDS card No.: 34-0394). Further, the crystallite diameter of the obtained fine particles was 21 nm, the average primary particle diameter was 27 nm, crystallite diameter:average primary particle diameter=1:1.3, and the variation coefficient of the particle diameter was 0.21. Further, the obtained fine particles were observed by a transmission electron microscope, whereby they were found to be fine particles excellent in the uniformity. The transmission electron microscopic photograph is shown in FIG. 1.

Further, 450 g of the fine particles obtained as described above, 1,050 g of pure water and 225 mg of ammonium polyacrylate were put into a container with a cover and mixed, followed by dispersion treatment for 72 hours in a ball mill using zirconia balls with a diameter of 0.5 mm. Thereafter, the mixture was diluted with pure water to obtain a dispersion A having a CeO₂ concentration of 1 mass %.

This dispersion A had a median diameter of 71 nm. Further, a part of the dispersion A was put in a glass test tube having a diameter of 18 mm in an amount of 20 mL and left to stand for 10 days, whereby no supernatant phase appeared, and the dispersibility was very good.

### Example 2

Fine particles of CeO₂ crystal were obtained in the same manner as in Example 1 except that the time for heating the pulverized material was changed to 32 hours. The crystallite diameter of the obtained fine particles was 22 nm, the average primary particle diameter was 26 nm, crystallite diameter:average primary particle diameter=1:1.2, and the variation coefficient of the particle diameter was 0.22.

### Example 3

A starting material mixture was obtained in the same manner as in Example 1 except that the mixing proportions of cerium oxide (CeO₂), calcium carbonate (CaCO₃) and boron oxide (B₂O₃) were changed to 20.0%, 35.6% and 44.4%, respectively, as represented by mol % based on CeO₂, CaO and B₂O₃.

To this starting material mixture, the melting step and the rapid cooling step were applied in the same manner as in Example 1 to obtain an amorphous material.

The obtained amorphous material was pulverized for 8 hours by a dry ball mill using zirconia balls with 5 mm in diameter to obtain a pulverized material. The volume-based particle size distribution of the obtained pulverized material was within a range of from 0.6 μm to 17 μm, and its D₉₀ was 7.2 μm.

The obtained pulverized material was heated at 700° C. for two hours to precipitate CeO₂ crystal.

Then, this powder made of crystal-precipitated particles was added to an acetic acid aqueous solution, followed by stirring, centrifugal separation, washing with water and drying to obtain fine particles, in the same manner as in Example 1.

The crystallite diameter of the obtained fine particles was 9 nm, the average primary particle diameter was 9 nm, crystallite diameter:average primary particle diameter=1:1.0, and the variation coefficient of the particle diameter was 0.21.

### Example 4 (Comparative Example)

Fine particles of CeO₂ crystal were obtained in the same manner as in Example 2 except that pulverization of the amorphous material was not carried out. The crystallite diameter of the obtained fine particles was 32 nm, the average primary particle diameter was 35 nm, crystallite diameter:average primary particle diameter=1:1.1, and the variation coefficient of the particle diameter was 0.42. It is thus evident that as compared with Example 2, particles having a large fluctuation in the particle diameter were obtained.

### Example 5 (Comparative Example)

A amorphous material obtained in the same manner as in Example 3 was pulverized for one hour by a dry ball mill using zirconia balls with 10 mm in diameter to obtain a pulverized material. The volume-based particle size distribution of the obtained pulverized material was within a range of from 0.9 μm to 230 μm.

The obtained pulverized material was heated at 720° C. for 8 hours to precipitate CeO₂ crystal. The obtained crystal-precipitated particles were added to an acetic acid aqueous solution, followed by stirring, centrifugal separation, washing with water and drying to obtain fine particles of CeO₂ crystal, in the same manner as in Example 1.

The crystallite diameter of the obtained fine particles was 21 nm, the average primary particle diameter was 23 nm, crystallite diameter:average primary particle diameter=1:1.1, and the variation coefficient of the particle diameter was 0.44. It is thereby evident that as compared with Example 3, particles having a large fluctuation in the particle diameter were obtained.

### Example 6

Cerium oxide (CeO₂), zirconium oxide (ZrO₂), calcium carbonate (CaCO₃) and boron oxide (B₂O₃) were weighed so that they became 13.8%, 11.3%, 37.5% and 37.5%, respectively, as represented by mol % based on CeO₂, ZrO₂, CaO and B₂O₃, and thoroughly mixed by means of a mixer to obtain a starting material mixture.

The obtained starting material mixture was filled in a platinum container (containing 10 mass % of rhodium) provided with a nozzle for dropwise addition of a melt, and heated at 1,500° C. for two hours in an electric furnace using molybdenum silicate as a heating element and completely melted. Then, the rapid cooling step was carried out in the same manner as in Example 1 to obtain a flake-form solid. The obtained flake-form solid was transparent and was found to be an amorphous material as a result of the powder-X-ray diffraction.

The obtained amorphous material was pulverized for 8 hours by a dry ball mill using zirconia balls with 5 mm in diameter. The volume-based particle size distribution of the obtained pulverized material was within a range of from 0.5 μm to 16 μm, and its D₉₀ was 6.9 μm.

Further, the crystallization step and the separation step were carried out in the same manner as in Example 1 except that the crystallization conditions were changed to 750° C. for 8 hours, to obtain fine particles.

The mineral of the obtained fine particles was cubic crystal, and the fine particles were confirmed to be highly crystalline fine particles made of a CeO₂-ZrO₂ solid solution (density: 6.7 g/cm³). Further, the crystallite diameter of the obtained fine particles was 11 nm, the average primary particle diameter was 12 nm, crystallite diameter:average primary particle diameter=1:1.1, and the variation coefficient of the particle diameter was 0.28.

### Example 7

Cerium oxide (CeO₂), zirconium oxide (ZrO₂), calcium carbonate (CaCO₃) and boron oxide (B₂O₃) were weighed so that they became 13.5%, 11.5%, 37.5% and 37.5%, respectively, as represented by mol % based on CeO₂, ZrO₂, CaO and B₂O₃, followed by a melting step and rapid cooling step in the same manner as in Example 6 to obtain an amorphous material.

The obtained amorphous material was pulverized for 8 hours by a dry ball mill using zirconia balls with 5 mm in diameter, to obtain a pulverized material. The volume-based particle size distribution of the obtained pulverized material was within a range of from 0.6 μm to 17 μm, and its D₉₀ was 7.1 μm.

Further, the crystallization step and the separation step were carried out in the same manner as in Example 6 to obtain fine particles. The mineral of the obtained fine particles was cubic crystal, and the fine particles were confirmed to be highly crystalline fine particles made of a CeO₂-ZrO₂ solid solution (density: 6.6 g/cm³). Further, the crystallite diameter of the obtained fine particles was 12 nm, the average primary particle diameter was 13 nm, crystallite diameter:average primary particle diameter=1:1.1, and the variation coefficient of the particle diameter was 0.29.

### Example 8

Cerium oxide (CeO₂), zirconium oxide (ZrO₂), calcium carbonate (CaCO₃) and boron oxide (B₂O₃) were weighed so that they became 8.6%, 13.4%, 39.0% and 39.0%, respectively, as represented by mol % based on CeO₂, ZrO₂, CaO and B₂O₃, followed by a melting step and rapid cooling step in the same manner as in Example 6 to obtain an amorphous material.

The obtained amorphous material was pulverized for 8 hours by a dry ball mill using zirconia balls with 5 mm in diameter, to obtain a pulverized material. The volume-based particle size distribution of the obtained pulverized material was within a range of from 0.7 μm to 17 μm, and its D₉₀ was 7.3 μm.

Further, the crystallization step and the separation step were carried out in the same manner as in Example 6 to obtain fine particles. The mineral of the obtained fine particles was cubic crystal, and the fine particles were confirmed to be highly crystalline fine particles made of a CeO₂-ZrO₂ solid solution (density: 6.5 g/cm³). Further, the crystallite diameter of the obtained fine particles was 11 nm, the average primary particle diameter was 11 nm, crystallite diameter:average primary particle diameter=1:1.0, and the variation coefficient of the particle diameter was 0.29.

### Example 9

Cerium oxide (CeO₂), zirconium oxide (ZrO₂), lanthanum oxide (La₂O₃), calcium carbonate (CaCO₃) and boron oxide (B₂O₃) were weighed so that they became 12.4%, 11.3%, 1.4%, 37.5% and 37.5%, respectively, as represented by mol % based on CeO₂, ZrO₂, La₂O₃, CaO and 8₂O₃, followed by a melting step and rapid cooling step in the same manner as in Example 6 to obtain an amorphous material.

The obtained amorphous material was pulverized for 8 hours by a dry ball mill using zirconia balls with 5 mm in diameter, to obtain a pulverized material. The volume-based particle size distribution of the obtained pulverized material was within a range of from 0.7 μm to 18 μm, and its D₉₀ was 7.4 μm.

Further, the crystallization step and the separation step were carried out in the same manner as in Example 6 to obtain fine particles. The mineral of the obtained fine particles was cubic crystal, and the fine particles were confirmed to be highly crystalline fine particles made of a CeO₂-ZrO₂-La₂O₃ solid solution (density: 6.4 g/cm³). Further, the crystallite diameter of the obtained fine particles was 9 nm, the average primary particle diameter was 12 nm, crystallite diameter:average primary particle diameter=1:1.3, and the variation coefficient of the particle diameter was 0.30.

### INDUSTRIAL APPLICABILITY

The fine particles of crystalline oxide obtainable by the present invention have high crystallinity, are excellent in uniformity of the composition and particle diameter and have a small particle diameter. Accordingly, such fine particles can be used particularly suitably for precision polishing in a process for producing semiconductor devices. Further, such fine particles are also effective as a polishing material for glass, an ultraviolet absorber for an ultraviolet absorption glass or ultraviolet absorption film, a gas sensor, an electrode material for solid oxide fuel cells or a co-catalyst for cleaning an automobile exhaust gas.

The entire disclosure of Japanese Patent Application No. 2007-233137 filed on Sep. 7, 2007 including specification, claims, drawings and summary is incorporated herein by reference in its entirety.

What is claimed is:

1. A process for producing fine particles of crystalline oxide, which comprises:
a step of obtaining a melt containing an oxide of M (M is at least one member selected from the group consisting of Ce,Ti, Zr, Al, Fe, Zn, Mn, Cu, Co, Ni, Bi, Pb, In, Sn and rare earth elements (excluding Ce)) and B₂O₃,
a step of rapidly cooling the melt to form an amorphous material,
a step of pulverizing the amorphous material to obtain a pulverized material having a volume-based particle size distribution within a range of from 0.1 to 40 μm,
a step of heating the pulverized material to precipitate a crystalline oxide containing M in the pulverized particles, and
a step of separating components other than the crystalline oxide containing M from the crystal-precipitated particles to obtain fine particles of crystalline oxide containing M, in this order.

2. The process for producing fine particles of crystalline oxide according to claim 1, wherein D₉₀ of the pulverized material is at most 20 μm, where D₉₀ is a particle diameter when in a volume-based cumulative particle size distribution curve of the pulverized material, the integrated amount as accumulated from the small particle size side, becomes to be 90%.

3. The process for producing fine particles of crystalline oxide according to claim 1, wherein the melt is a melt containing, as represented by mol % based on oxide, from 5 to 70% of the oxide of M and from 30 to 95% of B₂O₃.

4. The process for producing fine particles of crystalline oxide according to claim 1, wherein the melt further contains an oxide of R (R is at least one member selected from the group consisting of Mg, Ca, Sr and Ba).

5. The process for producing fine particles of crystalline oxide according to claim 4, wherein the melt is a melt containing, as represented by mol % based on oxide, from 5 to 50% of the oxide of M, from 10 to 50% of the oxide of R and from 30 to 75% of B₂O₃.

6. The process for producing fine particles of crystalline oxide according to claim 4, wherein the proportion of the oxide of M contained in the melt is from 5 to 50 mol % to the total amount of the oxide of R and B₂O₃.

7. The process for producing fine particles of crystalline oxide according to claim 4, wherein the proportion of the oxide of R contained in the melt is from 20 to 50 mol % to B₂O₃.

8. The process for producing fine particles of crystalline oxide according to claim 1, wherein M is Ce.

9. The process for producing fine particles of crystalline oxide according to claim 1, wherein the amorphous material is in a flake form or a fiber form.

10. The process for producing fine particles of crystalline oxide according to claim 1, wherein the temperature for heating the pulverized material is from 600 to 900° C.

11. The process for producing fine particles of crystalline oxide according to claim 1, wherein the components other than the oxide containing M in the crystal-precipitated particles are eluted by an acid and separated from the oxide crystal containing M.

12. The process for producing fine particles of crystalline oxide according to claim 1, wherein D₉₀ of the pulverized material is at most 10 μm, and the volume-based particle size distribution of the pulverized material is within a range of from 0.1 to 20 μm, where D₉₀ is a particle diameter when in a volume-based cumulative particle size distribution curve of the pulverized material, the integrated amount as accumulated from the small particle size side, becomes to be 90%.

13. Fine particles of crystalline oxide, wherein the ratio of the crystallite diameter calculated by using Scherrer's method from the X-ray diffraction measurement to the average primary particle diameter calculated by spherical approximation from the specific surface area measurement by BET method is within a range of crystallite diameter:average primary particle diameter=1:0.8 to 1:2.5; the average primary particle diameter is from 5 to 100 nm; and the variation coefficient of the particle diameter is from 0.05 to 0.3, where the variation coefficient of the particle diameter is a value obtained by dividing the standard deviation of the particle size distribution obtained by measurement from the transmission electron microscopic photograph, by the number average particle diameter.

14. The fine particles of crystalline oxide according to claim 13, wherein the ratio is within a range of crystallite diameter:average primary particle diameter=1:1.0 to 1:1.8, and the average primary particle diameter is from 10 to 50 nm.
